(19) United States
(12) Patent Application Publication
(10) Pub. No.: US 2006/0262235 A1
(43) Pub. Date: Nov. 23, 2006

(54) Method of producing a colour display device and colour display device

(75) Inventors: Joost P. A. Vogels, Leende (NL); Dirk J. Broer, Geldrop (NL); Roel Penterman, Eindhoven (NL); Stephen I. Klink, Breda (NL); Paulus C. Duineveld, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/569,259

(22) PCT Filed: Aug. 17, 2004
(86) PCT No.: PCT/IB04/02681

§ 371 Date: Feb. 21, 2006

(30) Foreign Application Priority Data
Aug. 23, 2003 (GB) 0319908.0
Sep. 30, 2003 (GB) 0322804.6

(51) Int. Cl. G02F 1/1335

(52) U.S. Cl. 349/10

(57) ABSTRACT

The multi-colour liquid crystal display device (1) of the present invention has a plurality of discrete liquid crystal elements (110, 130, 150) that are carried by a surface of a carrier (10). The liquid crystal elements (110, 130, 150), which cover respective parts of the electrode structure (12), each have a polymer layer (114, 134, 154), which encloses a cholesteric liquid crystal material (102, 122, 142) between the polymer layer and the surface of the carrier (10). The discrete liquid crystal elements (110, 130, 150) have been formed by the individual deposition of discrete droplets of a liquid comprising the various cholesteric liquid crystal materials (102, 122, 142) and a polymer precursor followed by exposure of the droplets to a stimulus triggering the polymerization of the polymer precursor.

The present invention relates to a method of producing a display device comprising a plurality of discrete liquid crystal elements on a surface of a carrier.

The present invention also relates to a display device comprising a carrier comprising a plurality of cholesteric liquid crystal elements on a surface of a carrier.

Nowadays, many flat display devices utilize the electro-optical effect of liquid crystal materials to implement the display functionality. A special class of liquid crystal displays (LCDs) are the cholesteric texture liquid crystal (CTLC) displays. An important characteristic of CTLC displays is that they are infinitely multiplexible, i.e., the respective LC elements remain in the state that they are driven into. This is caused by the bistable nature of cholesteric liquid crystal (CLC) materials, and has the important advantage of low power consumption in the standby mode of the CTLC device, because the state of the LC elements does not have to be refreshed. An additional advantage of CTLC devices is that they have an increased cell gap tolerance, i.e., the length of the optical path through the LC material, compared to displays utilizing other types of LC materials.

CLC materials can adopt a number of different textures or states. In the so-called planar texture, the CLCs are arranged in a screw-like fashion. Depending on the CLC materials, the periodicity or pitch can vary from fifty nanometers to many micrometers. This texture can rotate the polarization of the incident light.

One form of a planar texture is the perfect planar texture, which has a single domain structure in which the helical axes of the molecules are aligned in the same direction. Due to the single domain structure in this orientation, the incident light is reflected specularly in a narrow part of the electromagnetic spectrum, which gives the display a bright appearance.

A non-perfect planar state, which typically incorporates a multitude of domains per LC element, can also be obtained. The axes of the molecules in one domain are aligned in the same direction, while the helical axis orientation differs for each domain. An advantage of this multi-domain structure is that the incoming light is diffusely reflected. Although this broadens the spectral width of the part of the visible spectrum with which the LC element has an interaction compared to perfect planar orientations, thus leading to less intense colours, it improves the viewing angle range for the display area, which is desirable if the display device has to be viewable under a wide range of viewing angles. The planar states can be achieved and/or stabilized by the use of appropriate orientation layers.

In the absence of orientation layers or as the result of the application of an appropriate voltage, a CLC material adopts a so-called focal conic texture. In the focal conic texture, a CLC element contains many domains, which are oriented more or less randomly throughout the cell. In this focal conic state, the layer scatters light because of the abrupt change of refractive indices at the domain boundaries. The net effect is that the incident light is not reflected.

In WO99/21052, a method for producing a colour display device having CTLC elements is disclosed. A plurality of twisting agents is deposited on a substrate, after which a second substrate having spacing elements on its surface is bonded to the first substrate, thus forming a two-substrate device having interstitial regions with twisting agents in each of those regions, with different interstitial regions having different twisting agents. A twisting agent transfers a nematic LC material into a cholesteric LC material and the twisting agent determines the colours of the reflected light. The various interstitial regions are filled with the nematic LC material, after which the twisting agents are dissolved in the nematic LC material, thus forming interstitial regions having interactions with bandwidths of light centered around different wavelengths, thus forming a multi-colour display device.

A drawback of this method is that it is a complex and time-consuming batch wise process. For instance, the second substrate has to be fitted with the spacing elements and the interstitial regions have to be filled with the nematic LC material, which can be especially time-consuming for large multi-colour LCDs, both adding to the cost of the production process and the end product, i.e., the multi-colour LCD.

Inter alia, it is an object of the present invention to provide a more facile production method of a display device according to the opening paragraph.

It is another object of the present invention to provide a display device according to the opening paragraph that can be marketed at a lower price.

According to a first aspect of the present invention, there is provided a method of producing a multi-colour liquid crystal display device comprising a plurality of discrete liquid crystal elements on a surface of a carrier, the method comprising the steps of depositing a plurality of discrete droplets on the carrier surface, the plurality of droplets having at least a first subset and a second subset, a droplet from the first subset being of a first liquid comprising a mixture of a first cholesteric liquid crystal material for interacting with light having a wavelength in a first part of the visible spectrum and a first polymer precursor material, and a droplet from the second subset being of a second liquid comprising a mixture of a second cholesteric liquid crystal material for interacting with light having a wavelength in a second part of the visible spectrum and a second polymer precursor material; forming a first subset of the plurality of discrete liquid crystal elements by exposing the first subset of discrete droplets to a stimulus for polymerizing the first polymer precursor material of each of said droplets into a first discrete polymer layer enclosing the first cholesteric liquid crystal material between said first layer and the carrier surface; and forming a second subset of the plurality of discrete liquid crystal elements by exposing the second subset of discrete droplets to a stimulus for polymerizing the second polymer precursor material of each of said droplets into a second discrete polymer layer enclosing the second cholesteric liquid crystal material between said second layer and the carrier surface.

By depositing discrete droplets of mixtures of different CTLC materials and a polymer precursor on the carrier surface, the discrete electro-optical colour elements, e.g., colour pixels or colour sub-pixels, are predefined by the droplets. Any number of subsets, i.e., groups of liquid crystal elements having different colour characteristics can be formed this way, e.g., three subsets for a red-green-blue (RGB) colour device, with each of the colours being defined by one of the subsets. Such a liquid crystal element may be formed by a single droplet or, if desired, formed by merging a plurality of droplets together by depositing them on the same location, i.e., on top of each other, on the carrier surface. The droplets can simply be deposited by means of known printing techniques such as piezo-electric or continuous inkjet printing or bubble jet printing. Depending on the polymer precursor, the polymerization reaction can be initiated over the whole carrier surface by applying an appropriate stimulus like UV light exposure, heat, electron beam exposure or other known suitable polymerization initiator. The various subsets of droplets may be printed at the same time using multi-nozzle printers, or may be printed sequentially. Consequently, the production method of the present invention is cheaper and more versatile than the prior art production method, since, for instance, no additional second substrate is required due to the presence of the plurality of discrete polymer layers, no time-consuming filling with a LC material is required and no twisting agents are required to induce effects in the LC material.

An additional advantage is that the size of the multi-colour liquid crystal display device to be produced on a single carrier can be increased without causing an excessive increase in production cost, due to the fact that photolithographic masks are not necessarily required in the production process of the optical stack of the multi-colour liquid crystal display device of the present invention. Also, there is no technical limitation to the number of multi-colour liquid crystal display devices that may be produced on a single carrier, which improves efficiency of the production process, thus further reducing production cost.

The carrier surface may be modified by depositing an electrode structure or a part of a top-bottom electrode structure for controlling the liquid crystal elements and by an orientation layer such as a rubbed polyimide orientation layer or a photo-aligning material like a cinnamate or a coumarin containing polymer prior to the deposition of the droplets, in order to ensure that the CTLC material adopts the required orientation in the liquid crystal element.

An additional advantage of the production method of the present invention is that the shape of the arrangement of the plurality of discrete liquid crystal elements is no longer governed by the shape of the carrier surface. By depositing the liquid crystal material at the pixel level, the liquid crystal elements can be deposited on a predefined part of the carrier surface, thus forming predefined shapes like images. This is particularly advantageous for colour liquid crystal display being arranged to display fixed images.

In an embodiment, the step of depositing the plurality of discrete droplets is preceded by the step of depositing a pattern of wall structures on the carrier surface for creating a plurality of bordered domains on the carrier surface, a droplet from the plurality of discrete droplets being deposited in such a bordered domain. The deposition of a plurality of wall structures has the advantage that the wall structures prevent the individual droplets from further spreading, which prevents droplets from becoming too thin or from merging with a neighbouring droplet. Consequently, liquid crystal elements having a composition of a liquid crystal element with a high aperture ratio can be obtained.

Alternatively, the step of depositing a plurality of discrete droplets is preceded by the step of depositing a plurality of regions of a nonwetting material on the carrier surface. The contact angle of the droplets with this nonwetting layer is substantially larger than the contact angle of the droplets with the carrier substrate. Consequently, the nonwetting regions prevent the excessive spreading of droplets and neighbouring droplets from merging. In a further embodiment, the method further comprises the steps of depositing a further orientation layer over the plurality of discrete liquid crystal elements; depositing a first further subset of a further plurality of discrete droplets over the first subset of discrete liquid crystal elements, a droplet from the first further subset of the further plurality of discrete droplets being of a first further liquid comprising a first further cholesteric liquid crystal material and a first further polymer precursor material; depositing a second further subset of the further plurality of discrete droplets over the second subset of discrete liquid crystal elements, a droplet from the second further subset of the further plurality of discrete droplets being of a second further liquid comprising a second further cholesteric liquid crystal material and a second further polymer precursor material; modifying the first subset of discrete liquid crystal elements by exposing the first further subset of discrete droplets to a further stimulus for polymerizing the first further polymer precursor material of each droplet into a first further discrete polymer layer enclosing the first further cholesteric liquid crystal material between said first further layer and the further orientation layer; and modifying the second subset of discrete liquid crystal elements by exposing the second further subset of discrete droplets to a further stimulus for polymerizing the second further polymer precursor of each droplet into a second further discrete polymer layer enclosing the second further cholesteric liquid crystal material between said second further layer and the further orientation layer. This has the advantage that stacked multi-colour display devices can be produced in a simpler way compared to prior art production techniques. In addition, due to the fact that the polymer layers can be kept thin, the resulting display suffers less from parallax. Furthermore, the electrode structure to drive the stacked LC elements can be integrated on the bottom substrate.

After the formation of the liquid crystal elements, the multi-colour liquid crystal display device may be further processed. For instance, the method of the present invention may further comprise the step of depositing a further electrode structure on a polymer layer of the plurality of discrete liquid crystal elements to produce a multi-colour liquid crystal display device having liquid crystal elements sandwiched between a bottom electrode structure and a top electrode structure.

In addition, the method may further comprise the steps of covering the plurality of discrete liquid crystal elements with a light absorbing coating in case the multi-colour CTLC display device is of a reflective type.

According to a second aspect of the invention, there is provided a multi-colour liquid crystal display device comprising a plurality of discrete liquid crystal elements on a surface of a carrier, the plurality of discrete liquid crystal elements at least comprising a first subset and a second subset, each liquid crystal element from the first subset comprising a first discrete polymer layer enclosing a first cholesteric liquid crystal material for interacting with light having a wavelength in a first part of the visible spectrum between said first layer and the carrier surface; and each liquid crystal element from the second subset comprising a second discrete polymer layer enclosing a second cholesteric liquid crystal material for interacting with light having a wavelength in a second part of the visible spectrum between said second layer and the carrier surface.

Such a display device can be formed by executing the steps of the method of producing a multi-colour liquid crystal display device comprising a plurality of discrete liquid crystal elements on a carrier surface of the present invention. It is emphasized that the aforementioned various advantageous embodiments of said method could be used to produce analogous advantageous embodiments of the multi-colour liquid crystal display device of the present invention.

An additional advantage is obtained if the first cholesteric liquid crystal material has a first pitch and the first further cholesteric liquid crystal material has a first further pitch, the first pitch and the first further pitch being of opposite sign and being of substantially the same magnitude; and the second cholesteric liquid crystal material has a second pitch and the second further cholesteric liquid crystal material has a second further pitch, the second pitch and the second further pitch being of opposite sign and being of substantially the same magnitude. In case of a reflective multi-colour CTLC display device, such liquid crystal elements will reflect both right-handed and left-handed light of the selected part of the visible spectrum, this yielding a reflective display device having a better light reflection yield than prior art reflective CTLC display devices using a single CTLC material for a subset of liquid crystal elements, which causes half of the incoming light in the selected part of the visible spectrum to be lost.

A further additional advantage is obtained if the carrier is at least substantially transparent, the first further cholesteric liquid crystal material being suited to interact with light having a wavelength in a first further part of the visible spectrum; and the second further cholesteric liquid crystal material being suited to interact with light having a wavelength in a second further part of the visible spectrum. Such a transmissive multi-colour CTLC display device is much easier and much cheaper to produce than comparable prior art transmissive multi-colour CTLC display devices, where complex production processes were required to stack the various CTLC materials on top of each other.

A yet further additional advantage is obtained if the multi-colour liquid crystal display device comprises a flexible carrier. A well-known problem with having a substantially continuous layer of liquid crystal elements between two flexible substrates, for instance as proposed in an embodiment of WO99/21052, is that upon bending the surface, the stress on the inner and outer surfaces of the display device can cause damage to those surfaces, thus damaging the LC pixels of the multi-colour liquid crystal display device. The multi-colour liquid crystal display device of the present invention suffers less, if at all, from this problem. Since the liquid crystal elements are separated from each other, the outer surface does not experience tensile loading forces when the substrate is bent, thus providing an improved flexible multi-colour liquid crystal display device.

The invention is described in more detail and by way of non-limiting examples with reference to the accompanying drawings, wherein:

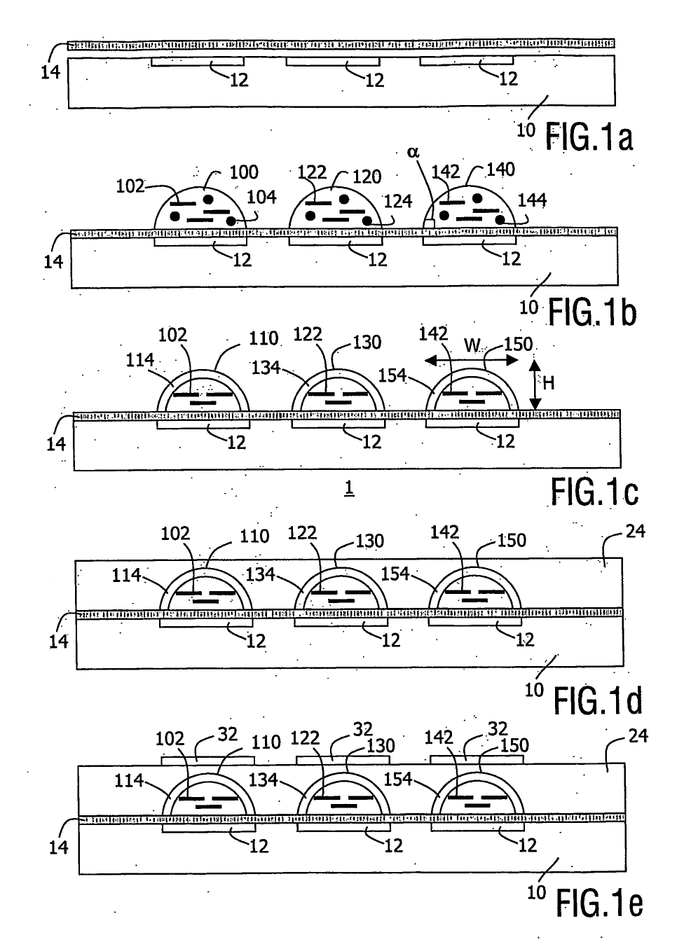

FIGS. 1-3 schematically depict various embodiments of the method and multi-colour liquid crystal display device of the present invention; and

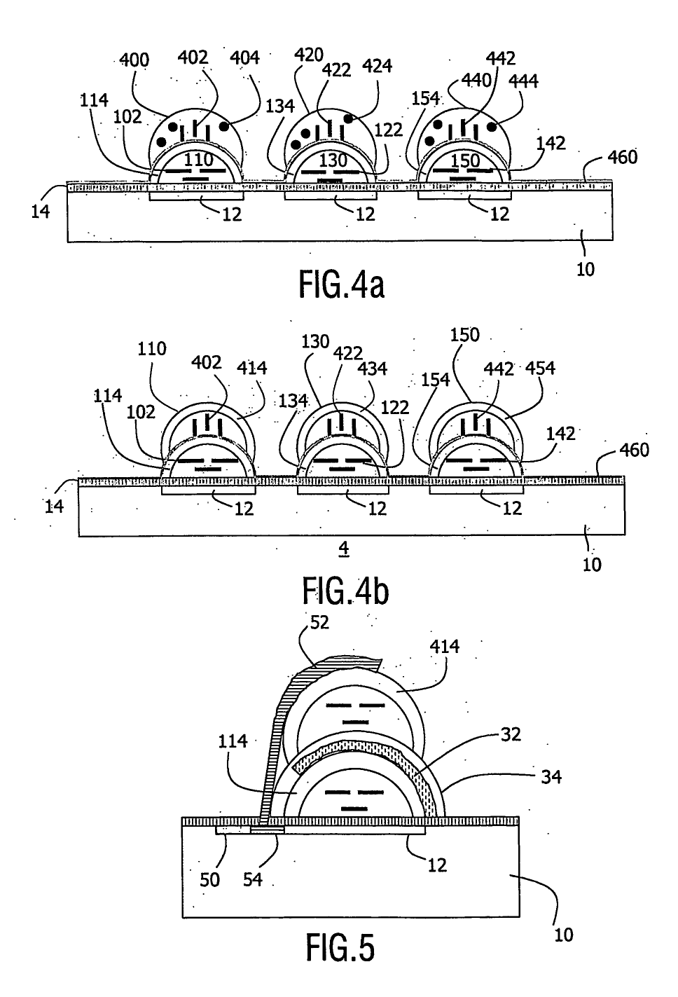

FIGS. 4-5 schematically depict further embodiments of the multi-colour liquid crystal display device of the present invention.

It should be understood that the Figures are merely schematic and are not drawn to scale. It should also be understood that the same reference numerals are used throughout the Figures to indicate the same or similar parts.

FIG. 1a shows a carrier 10 including an optional electrode structure 12. It is emphasized that FIG. 1 and the following Figs show an embedded electrode structure 12 for reasons of clarity only. It should be understood that the surface of the carrier 10 preferably may also be defined by placement of the electrode structure 12 on top of the carrier 10. The electrode structure 12 can be formed on top of the carrier 10 from known materials, e.g., Indium Tin Oxide (ITO), and by known techniques for forming electrode structures on a carrier 10. The carrier 10 may comprise any suitable material, e.g., glass, polymer, or even non-obvious materials as modified wood, ceramics or modified paper.

Optionally, the surface of carrier 10 that carries the electrode structure 12 may also be further modified prior to the formation of the cholesteric liquid crystal elements on the surface. An orientation layer 14 may be deposited on the surface of carrier 10 prior to the deposition of the liquid crystal elements. The orientation layer 14 may be formed from known materials such as polyimides, which may be a rubbed polyimide such as AI3046, which is supplied by the JSR electronics company of Japan to achieve a desired orientation direction of the liquid crystal materials. Alternatively, photo-aligning materials such as cinnamates and coumarin may be used, which induce orientation in a liquid crystal material after being exposed to linearly polarized light.

In a next step, the precursors for a plurality of discrete liquid crystal elements are deposited on the surface of carrier 10. The result of this depositing step is shown in FIG. 1b, where a plurality of discrete droplets 100, 120 and 140 have been deposited on the carrier surface. The discrete droplet 100 is part of a first subset of the plurality of discrete droplets, and is formed of a liquid comprising a mixture of a first cholesteric liquid crystal material 102 for interacting with light having a wavelength in a first part of the visible spectrum and a first polymer precursor material 104. The discrete droplet 120 is part of a second subset of the plurality of discrete droplets and is formed of a second liquid comprising a mixture of a second cholesteric liquid crystal material 122 for interacting with light having a wavelength in a second part of the visible spectrum and a second polymer precursor material 124, which may be the same material as the first polymer material 104. The discrete droplet 140 is part of a third subset of the plurality of discrete droplets and is formed of a third liquid comprising a mixture of a third cholesteric liquid crystal material 142 for interacting with light having a wavelength in a third part of the visible spectrum and a third polymer precursor material 124, which may be the same material as the first polymer precursor material 104 and/or the second polymer precursor material 124. A single polymerization initiator or various polymerization initiators may also be present in the droplets 100, 120 and 140 to start a polymerization reaction upon subjecting the droplets to an appropriate stimulus.

The first cholesteric liquid crystal material 102, the second cholesteric liquid crystal material 122 and the third cholesteric liquid crystal material 142 can be chosen to define the three primary colours of the multi-colour liquid crystal device, e.g. RGB colours. However, it will be understood by those skilled in the art that the number of different subsets of droplets having different cholesteric liquid crystal materials can be increased to form a more complex multi-colour liquid crystal device or reduced to for instance form a dual-colour liquid crystal device without departing from the scope of the present invention.

The deposition of the droplets 100, 120 and 140 can be achieved by means of known printing techniques such as piezo-electric inkjet printing, continuous printing and bubble jet printing. Each of the droplets may have been deposited as single droplets or as a deposition of a plurality of droplets in one location on the surface of the carrier 10 in order to achieve a large droplet comprising a plurality of smaller droplets.

The printer used for the deposition of the droplets 100, 120 and 140 may be a single-nozzle printer, in which case the droplets are printed in a sequential fashion, or a multi-nozzle printer with all of the nozzles connected to a single ink reservoir, in which case a plurality of droplets within a single subset can be printed simultaneously. Alternatively, the printer used for the deposition of the droplets 100, 120 and 140 may be a multi-nozzle printer with subsets of the nozzles being connected to reservoirs containing the respective first, liquids from which droplets 100, 120 and 140 are to be formed, in which case the droplets 100, 120 and 140 from several subsets of the plurality of discrete droplets may be printed at the same time in a parallel printing step, or a multi-head multi-nozzle printer with the nozzles of a printing head being arranged to print one of the subsets of the plurality of discrete droplets. Such arrangements make the production process of the multi-colour liquid crystal display device more efficient. Other printing arrangements may also be feasible without departing from the scope of the present invention.

In a next step, the droplets 100, 120 and 140 are exposed to a stimulus for initiating a polymerization reaction of the polymer precursor materials 104, 124 and 144. Such a stimulus may for instance be exposure to UV light or heat if the polymerization reaction to be induced in the respective droplets 100, 120 and 140 is of a photo-induced or thermally induced type, respectively. Obviously, a suitable polymerization initiator has to be chosen accordingly. Polymerization can also be directly induced by an electron beam. In case of the first polymer precursor material 104, the second polymer precursor material 124 and the third polymer precursor material 144 being different materials, different stimuli may have to be applied to initiate the polymerization reactions in the various subsets of the discrete droplets 100, 120 and140.

Upon exposure of the droplets to the stimulus, the photo-initiated polymerization reaction taking place at the surface of the droplets 100, 120 and 140 and triggers a phase-separation within these droplets of the liquid crystal materials 102, 122 and 142 respectively. Consequently, the respective cholesteric liquid crystal materials 102, 122 and 142 are enclosed between the surface of the carrier 10 and the respectively formed discrete polymer layers 114, 134 and 154, thus forming the liquid crystal elements 110,130 and 150.

A non-limiting example of a suitable composition of the liquids to be deposited in droplet form as liquid crystal element precursors on a carrier for forming the liquid crystal elements of a RGB colour liquid crystal display device is as follows:

50 weight percent (wt %) of a suitable cholesteric liquid crystal (vide infra);

44.5 wt % photo-polymerizable isobornylmethacrylate (supplied by Sartomer) and 5.0 wt% of a stilbene dimethacrylate dye

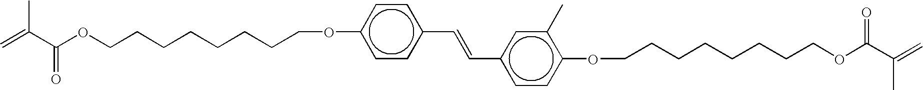

the synthesis of which has been disclosed in PCT patent application WO 02/42382 and which is hereby incorporated by reference, the two acrylates being an embodiment of the polymer precursor materials 104, 124 and 144; and

0.5 wt % benzildimethylketal, which is marketed by Ciba-Geigy under the trade name Irgacure 651, and which operates as a polymerization initiator.

Obviously, for a RGB-colour display, at least three different liquids comprising three different cholesteric liquid crystal materials have to be used. The first cholesteric liquid crystal material 102 for reflecting light in a red part of the visible spectrum may be a surface stabilized cholesteric texture mixture comprising 86 wt % chiral compound BL088 and 14 wt % nematic liquid crystal BL087, both compounds being available from Merck. These weight fractions give a reflection in a bandwidth of approximately 80-100 nm around a light wavelength of 630 nm.

The second cholesteric liquid crystal material 122 for reflecting light in a green part of the visible spectrum around a wavelength of 517 nm may be a surface stabilized cholesteric texture mixture comprising 90 wt % chiral compound BL088 and 10 wt % nematic liquid crystal BL006, both compounds being available from Merck, and the third cholesteric liquid crystal material 122 for reflecting light in a blue part of the visible spectrum around a wavelength of 420 nm may be a surface stabilized cholesteric texture mixture comprising 90 wt % chiral compound BDH98704 and 10 wt % nematic liquid crystal BL087, both compounds being available from Merck.

It is emphasized that the weight of the various fractions of the cholesteric liquid crystal materials 102, 122 and 142 as given above may be varied to tune both the size of the reflection bandwidth and the wavelength around which the reflection bandwidth is centered. Furthermore, it is emphasized that the above compositions are given by way of non-limiting example only and it should be appreciated by the skilled person that many other cholesteric liquid crystal materials including nematic liquid crystals with different twisting agents may be used without departing from the scope of the present invention.

A non-limiting example of the printing process of the present invention using the embodiment of the first liquid given above is as follows. In a test set-up, a 6×6 inch square glass carrier 10 was provided with an electrode structure 12 and a rubbed polyimide orientation layer AI3046 from the JSR electronics company of Japan. The dimensions were chosen to fit 9 small displays on the carrier 10. It should be understood that much larger dimensions for the carrier 10 are equally feasible, however. The carrier 10 was mounted on a computer controlled X-Y table having a variable speed of 1-30 mm/s.

A MicroDrop inkjet printing device was placed in a fixed position over the X-Y table. The dispensing head of the MicroDrop inkjet printing device included a glass capillary shaped into a nozzle on one side, the capillary being surrounded by a tubular piezo-activator for generating a pressure wave through the capillary. The pressure wave triggers the release of a droplet of the first liquid from the capillary. The shape of the pressure wave as well as the diameter of the capillary nozzle can be varied to control the size of the droplets to be released. Here, a pressure wave having a single block shape and a 50 micron nozzle have been used, leading to droplet diameters of 50-60 micron at the nozzle exit, each droplet having a volume of around 50 picoliter. Each of the droplets 100, 120 and 140 were formed on the carrier 10 by depositing approximately 80 droplets over a single part of the electrode structure 12. The various subsets of the droplets have been printed in a sequential fashion.

The droplets 100, 120 and 140 were exposed to UV light from a Philips TL08 UV lamp with a light intensity of 0.1 mW/cm² for 30 minutes at 40° C., after which the formation of the liquid crystal elements 110, 130 and 150 was completed. The inclusion of a compound having a chromophore strongly absorbing in the UV region of the electromagnetic spectrum, i.e., the stilbene dimethacrylate dye in the example above, causes a gradient in the UV intensity through the droplets 100, 120 and 140. This effect may be amplified by the UV absorptions of the other components of the liquids used to form these droplets, like the other components of the polymer precursor materials 104, 124 and 144 and the liquid crystal materials 102, 122 and 142. Consequently, the polymerization reaction predominantly takes place at the surface of the droplets 100, 120 and 140 facing the UV source.

FIG. 1c schematically depicts the formed liquid crystal elements 110, 130 and 150, which have been formed from respective droplets 100, 120 and 140. The liquid crystal elements 110, 130 and 150 have respective polymer layers 114, 134 and 154, which respectively have been formed from polymer precursors 104, 124 and 144, and which respectively enclose the different liquid crystal materials 102, 122 and 142 between their inner surfaces and the surface of carrier 10. This way, a plurality of discrete liquid crystal elements is formed that each have a discrete polymer layer with a substantially uniform thickness from the first contact point with the surface of the carrier 10 to the second contact point with the surface of the carrier 10. The multi-colour liquid crystal display device 1 shown in FIG. 1c may be the end product, in which case the electrode structure 12 may be an electrode structure suitable for controlling the liquid crystal materials 102, 122 and 142. At this stage, it is pointed out that the use of the wording ‘discrete’ to define a property of the droplets 100, 120 and 140 or a property of the polymer layers 114, 134 and 154, should not be interpreted to mean that the droplets 100, 120 and 140 or the polymer layers 114, 134 and 154 have to be completely separated from each other. Minor contact areas between the droplets 100, 120 and 140 or the polymer layers 114, 134 and 154 may exist near the surface of the carrier 10 without departing from the scope of the present invention. It will be understood that the size of such contact areas between two neighbouring droplets will have to remain small enough to prevent neighbouring droplets from merging.

Furthermore, it is emphasized that the droplets 100,120 and 140 in FIG. 1b and the liquid crystal elements 110, 130 and 150 in FIG. 1c have been represented having a hemi-spherical shape by way of non-limiting example only. A hemi-spherical shape may be preferable in application domains where the liquid crystal elements need to have lens-like characteristics, in which case the width W of the formed liquid crystal element is of a similar magnitude as height H. In contrast, in application domains where the liquid crystal elements have to operate as light valves, it may be preferable to have droplets with flattened surfaces in order to avoid unwanted optical effects, in which case width W can be much larger than height H. For example, W may be 1,000 micron or more, whereas H may typically be a few tenths of microns.

The shape adopted by the liquid crystal elements 110, 130 and 150 can be controlled by modifying the contact angle α of the droplets 100, 120 and 140 with the surface of the carrier 10. A low contact angle α, i.e. a good wetting, facilitates the formation of a relatively thin liquid crystal element having a relatively flat surface, especially if the element is formed from a large droplet formed by depositing a plurality of smaller droplets in the same location at the surface of the carrier 10. Liquid crystal elements 110, 130 and 150 having a relatively flat surface are advantageous, because the light passing through such liquid crystal elements at most experiences minor distortion, thus yielding a display device having a good image quality.

In FIG. 1d, an optional further processing step on the multi-colour liquid crystal display device 1 is depicted. In this step, a planarization layer 24 is deposited on top of the plurality of discrete liquid crystal elements 110, 130 and 150. The planarization layer 24, which may be formed from any known suitable planarization material, facilitates the deposition of further layers such as a further electrode structure 32 on the plurality of discrete liquid crystal elements 110, 130 and 150 opposite to the electrode structure 12, as shown in FIG. 1e. If, however, the liquid crystal elements 110, 130 and 150 are flat enough, the planarization layer 24 may be omitted and the further electrode structure 32 may also be deposited directly on top of the polymer walls 114, 134 and 154 of the respective liquid crystal elements 110, 130 and 150.

The further electrode structure 32 and the electrode structure 12 may form the rows and columns of the multi-colour liquid crystal display device 1. The further electrode structure may be formed from the polymer semiconductor material polyethylenethioxythiophene (PEDOT), which has the advantage that it can be processed at a temperature low enough not to damage the liquid crystal elements 110, 130 and 150.

At this stage, it is pointed out that although an interdigitated electrode structure employing in-plane switching effects can be used to change the state of the LC elements 110, 130 and 150, it is preferred to have both the electrode structure 12 and the further electrode structure 32 present in the display device of the present invention, because the desired state change in the LC elements 110, 130 and 150 can be achieved with much lower voltages than in the case of an interdigitated electrode structure, which for instance is preferable in terms of power consumption of the display device 1.

Alternatively, the layer 24 may be formed of a light absorbing coating in the case of the cholesteric liquid crystal elements 110, 130 and 150 being part of a reflective multi-colour liquid crystal display device 1. When the cholesteric liquid crystal elements 110, 130 and 150 are switched to their transmissive states, the light absorbing material will absorb the light passing through the cholesteric liquid crystal elements 110, 130 and 150, giving the display device 1 a black appearance.

It should be obvious to those skilled in the art that, where possible, the aforementioned processing steps may be combined or interchanged without departing from the teachings of the present invention.

When the contact angle α of the discrete droplets 100, 120 and 140 with the carrier 10 is low, care has to be taken that the discrete droplets 100, 120 and 140 do not merge with neighbouring discrete droplets, for obvious reasons. Also, height H of the droplets should be large enough to enable the proper functioning of the cholesteric liquid crystal materials 102, 122 and 142 in the corresponding liquid crystal elements 110, 130 and 150. Furthermore, the height H of the liquid crystal elements 110, 130 and 150 should be substantially constant throughout the full width W of the liquid crystal elements 110, 130 and 150 to ensure a proper LC effect in the liquid crystal elements 110, 130 and 150. Prevention of excessive spreading of the droplets 100, 120 and 140 will also improve the resolution of the multi-colour liquid crystal display device to be produced.

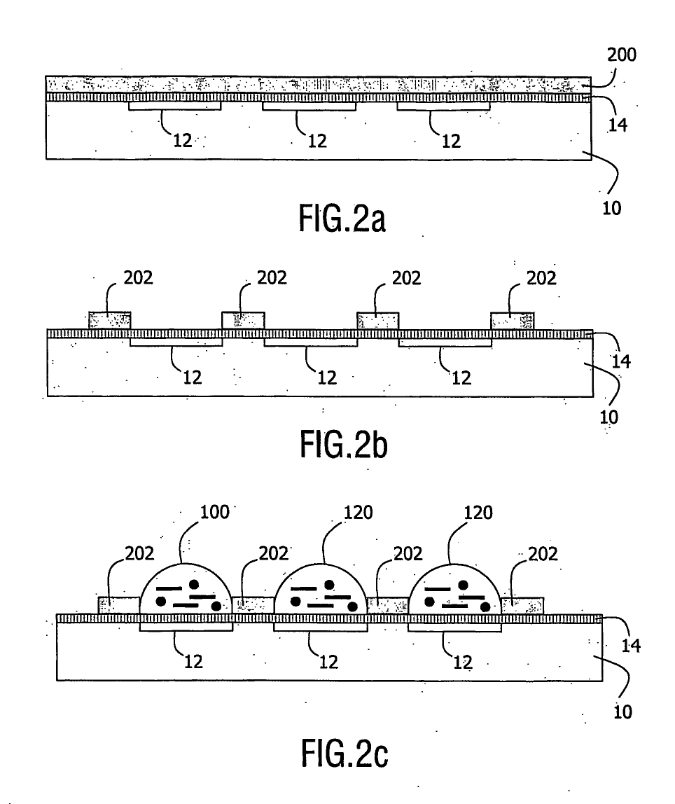

To enable the droplets 100, 120 and 140 to be printed on the surface of the carrier 10 assuming the desired form, the surface of carrier 10 may be modified prior to the deposition of the droplets 100, 120 and 140 to obtain a high aperture ratio. In FIG. 2, an example of such a modification is shown. FIG. 2a shows the carrier 10 with an electrode structure 12 and an orientation layer 16 on its surface, on which a photosensitive lacquer 200 is deposited. The photosensitive lacquer 200 is patterned in a photolithography step to form a pattern of wall structures 202 on the surface of the carrier 10, as shown in FIG. 2b. The pattern of wall structures 202 forms a relief pattern on the surface of the carrier 10. Alternatively, such a relief pattern can for instance also be obtained through photo-embossing, injection moulding, screenprinting, microcontact printing or 2-step photopolymerization techniques.

Next, the droplets 100, 120 and 140 are deposited in separate cavities between the wall structures 202 formed on the modified carrier 10, leading to an intermediate structure as shown in FIG. 2c. The deposition of the droplets 100, 120 and 140 into a bordered area has the advantage that spreading of the droplets is prevented and that the area can be filled up, thus providing droplets 100, 120 and 140 having a sufficient height H. At this point, it is emphasized that the shape of the wall structures 202 is not limited to the shape shown in this example. For instance, tapered walls or a multitude of stacked polymer layers forming the walls may also be used without departing from the scope of the present invention.

Furthermore, it will be understood that the modification steps of the surface of the carrier 10, e.g., the deposition of the optional orientation layer 14, may also take place after the development of the wall structures 202.

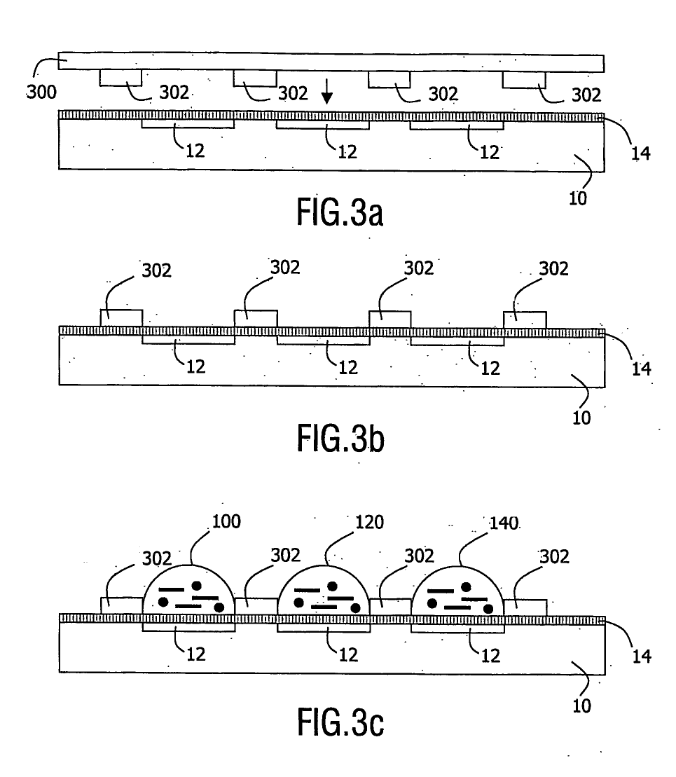

An alternative carrier modification method to achieve these advantages is shown in FIG. 3. In FIG. 3a, a stamp 300 such as a polydimethylsiloxane (PDMS) stamp is used to print regions 302 of a nonwetting material on the surface of the carrier 10. If required, the regions 302 may be offset printed on top of an optional orientation layer 14, such as the aforementioned AI3046. As an ink for the PDMS stamp 300, a homeotropic alignment material such as SE7511 from the Nissan Chemical Company from Japan may be used, although the use of other known offset printing inks, e.g., polyimides, is also possible.

The printing of the regions 302, which may be done with a stamp simultaneously contacting the whole surface of the carrier 10 or with a stamp that is rolled over the surface of the carrier 10, provides a plurality of bordered domains on the carrier surface, as shown in FIG. 3b. The nonwetting regions 302 ensure that the wetting on the surface carrier 10 predominantly takes place in the bordered domains upon deposition of the droplets 100, 120 and 140, thus yielding an intermediate structure of the multi-colour liquid crystal display device as shown in FIG. 3c. Good nonwetting properties of the carrier surface can be achieved by choosing a nonwetting material, e.g., the aforementioned SE7511, which causes the contact angle α of the droplets 100, 120 and 140 with the carrier 10 to be at least 10 degrees larger at the regions 302 compared to the contact angle α with the untreated regions of the carrier 10.

Rather than using offset printing, the regions 302 of a dewetting material may be also be deposited by alternative printing techniques such as microcontact printing, flexo-graphic printing, screen printing, inkjet printing, gravure printing, gravure-offset printing or tampon printing.

In FIGS. 4a and 4b, a further embodiment of the method and of a multi-colour liquid crystal display device according to the present invention is depicted.

A further plurality of droplets 400, 420 and 440 are deposited on top of the liquid crystal display elements 110, 130 and 150 of the multi-colour liquid crystal display device 1, leading to an intermediate structure as shown in FIG. 4a. The same printing techniques as described for the deposition of the droplets 100, 120 and 140 can be used for the deposition of the droplets 400, 420 and 440. It is pointed out that although the droplets 400, 420 and 440 as well as the liquid crystal elements 110, 130 and 150 have been depicted to have a hemi-spherical surface, this is by way of non-limiting example only, and other surface shapes as previously discussed, e.g., flattened surfaces, are at least equally acceptable. In fact, a flattened surface for the liquid crystal elements 110, 130 and 150 is preferred, because it facilitates the deposition of the droplets 400, 420 and 440 on top of the liquid crystal elements 110, 130 and 150.

The further plurality of droplets comprises a first further subset of droplets 400, with the droplets 400 being of a liquid comprising a first further cholesteric liquid crystal material 402 and a first further polymer precursor material 404. The first further subset of droplets 400 is deposited on top of the first subset of liquid crystal elements 110. The further plurality of droplets also comprises a second further subset of droplets 420, with the droplets 420 being of a liquid comprising a second further cholesteric liquid crystal material 422 and a second further polymer precursor material 424. The second further subset of droplets 420 is deposited on top of the second subset of liquid crystal elements 130. The further plurality of droplets may further comprise a third further subset of droplets 440 if a third subset of liquid crystal elements 140 is present, with the droplets 440 being of a liquid comprising a third further cholesteric liquid crystal material 442 and a third further polymer precursor material 444. The third further subset of droplets 440 is deposited on top of the third subset of liquid crystal elements 150.

Prior to the deposition of the plurality of droplets 400, 420 and 440 a further orientation layer 460 for aligning the cholesteric liquid crystal materials 402, 422 and 442 is deposited, which may be formed of the same materials as discussed for the orientation layer 14.

Next, the further plurality of droplets 400, 420 and 440 are provided with a stimulus for initiating a further polymerization reaction at the surface of the further plurality of droplets 400, 420 and 440. Again, this stimulus may be a stimulus as discussed for the formation of the liquid crystal elements 110, 130 and 150. A single stimulus may be sufficient if the first further polymer precursor material 404, the second further polymer precursor material 424 and the third further polymer precursor material 444 are the same materials or are at least responsive to the same stimulus. It will be obvious that the first further polymer precursor material 404, the second further polymer precursor material 424 and the third further polymer precursor material 444 may be the same materials as the first polymer precursor material 104, the second polymer precursor material 124 and the third polymer precursor material 144.

Upon completion of the further polymerization reaction, a multi-colour liquid crystal display device 4 as shown in FIG. 4b is obtained. The first further cholesteric liquid crystal material 402 of each of the individual droplets 400 has been enclosed between the further orientation layer 460 and a first further polymer layer 414, which is formed during the further polymerization reaction, thus yielding a plurality of modified liquid crystal elements 110. In analogy, the second further cholesteric liquid crystal material 422 of each of the individual droplets 420 has been enclosed between the further orientation layer 460 and a formed second further polymer layer 434, thus yielding a plurality of modified liquid crystal elements 130, and the third further cholesteric liquid crystal material 442 of each of the individual droplets 440 has been enclosed between the further orientation layer 460 and a formed third further polymer layer 454, thus yielding a plurality of modified liquid crystal elements 150.

It is pointed out that the further orientation layer 460 may be a continuous layer or may comprise discretely deposited domains over the various discrete liquid crystal elements 110, 130 and 150. In the latter case, various orientation materials may be used for the various domains without departing from the scope of the present invention.

Although not explicitly shown in FIGS. 4a and 4b, it will be understood by the skilled person that the discrete liquid crystal elements 110, 130 and 150 of the multi-colour display device 4 may also be separated from each as taught by the FIGS. 2 and 3 and the detailed description thereof, and that the earlier discussed further processing steps on the formed liquid crystal elements 110, 130 and 150 of the multi-colour display device 1, such as the application of a further electrode structure 32, a light absorbing layer and/or a planarization layer 24 may also be applied to the multi-colour display device 4.

A particular interesting property of CLCs is that they are able to reflect light and rotate the polarization direction of light in their planar state. According to Bragg's law, CLCs in their planar state can reflect visible light if the periodicity of the helical structure of the material matches the incident wavelength. In such a case, circularly polarized light with the same handedness of the chiral structure will be reflected. This effect may be utilized by choosing the various further cholesteric liquid crystal materials 402, 422 and 442 to have a pitch, i.e., a twisting magnitude of the cholesteric liquid crystal helix, that is of opposite sign and of similar magnitude as the pitch of the underlying cholesteric liquid crystal materials 102, 122 and 142. For instance, the chiral component of the first further cholesteric liquid crystal material 402 may be the mirror image of the chiral component on the first cholesteric liquid crystal material 102, the chiral component of the second further cholesteric liquid crystal material 422 may be the mirror image of the chiral component on the second cholesteric liquid crystal material 122, and the chiral component of the third further cholesteric liquid crystal material 442 may be the mirror image of the chiral component on the third cholesteric liquid crystal material 442. This is of particular advantage in case of a reflective multi-colour liquid crystal display device 4, because in its reflective mode, the liquid crystal elements 102, 122 and 142 will reflect both polarisation directions of the incident light rather than just a single direction, thus yielding a multi-colour liquid crystal display device 4 with stacked liquid crystal elements that is cheap to manufacture, and which has excellent brightness characteristics.

Alternatively, the various further cholesteric liquid crystal materials 402, 422 and 442 may be chosen to have an interaction with a different part of the visible spectrum than the underlying cholesteric liquid crystal materials 102, 122 and 142. In other words, the first further cholesteric liquid crystal material 402 may be suited to interact with light having a wavelength in a first further part of the visible spectrum, the second further cholesteric liquid crystal material 422 may be suited to interact with light having a wavelength in a second further part of the visible spectrum and the third further cholesteric liquid crystal material 442 may be suited to interact with light having a wavelength in a third further part of the visible spectrum.

This is particularly advantageous in a transmissive type multi-colour liquid crystal display device 4. For instance, the first cholesteric material 102 may be chosen to reflect light in the red part of the spectrum and the first further cholesteric material 402 may be chosen to reflect light in the green part of the spectrum, thus yielding a liquid crystal element 110 that transmits light from the blue part of the spectrum. In analogy, the second cholesteric material 122 may be chosen to reflect light in the blue part of the spectrum and the second further cholesteric material 422 may be chosen to reflect light in the green part of the spectrum, thus yielding a liquid crystal element 110 that transmits light from the red part of the spectrum and so on. Many colour combinations are possible without departing from the scope of the invention. It will be obvious that for such a transmissive device, both the carrier 10 and the electrode structure 12 should at least predominantly be made from transparent materials. A multi-colour liquid crystal display device 4 is obtained that is cheaper to make than prior art stacked element transmissive multi-colour LCDs, which could only be made by complex production methods, making the displays expensive. Also, the multi-colour liquid crystal display device 4 suffers less from parallax because the discrete polymer layers of the liquid crystal elements can be kept very thin; depending of the duration of the polymerization step in the formation of the various LC elements, the various discrete polymer layers can be kept as thin as approximately 10 micron. The present invention therefore provides an important advantage, since transmissive CTLC devices have huge potential because of the exceptionally bright colours they produce.

At this stage, it is pointed out that a top-bottom electrode structure may be obtained for the stacked multi-colour liquid crystal display device 4 by depositing a further electrode structure (not shown) over the first further polymer layers 414, the second further polymer layers 434 and the third further polymer layers 454.

Another possible electrode arrangement for a stacked multi-colour liquid crystal display device 4 is given in FIG. 5. An electrode structure 12 is deposited on the carrier 10, and is connected to a switch 50, e.g., a thin film transistor, via a conductive path 54. The electrode structure 12 is shown as an embedded structure for reasons of clarity only. The polymer layer 114 of the LC element 110 is covered by a further electrode structure 32, which may be a common electrode. The further electrodes structure 32 is covered by a passivation layer 34, which may be the same as the further orientation layer 460, or may be of a different material, in which case the further orientation layer 460 has to be added to cover the passivation layer 34. A second further electrode structure 52 covers the first further polymer layer, and is connected to the same conductive path as the electrode structure 12. Consequently, the electrode structure 12 and the second further electrode structure 52 are responsive to the same switch 50. The various electrode structures 12, 32 and 52 may be formed from any suitable materials including ITO and PEDOT. The arrangement shown in FIG. 5 has the advantage that the stacked liquid crystal elements 110, 130 and 150 can be driven using smaller voltages compared to an arrangement where only a top and a bottom electrode structure are present.

In the previously described embodiments of the present invention, most of the electrode structure 12, when present, has been covered by the various cholesteric liquid crystal elements 110, 130 and 150. This is not strictly necessary, however. Only a predefined part of the surface of carrier 10 of the multi-colour liquid crystal display device may carry a plurality of the various liquid crystal elements 110, 130 and 150 arranged in a corresponding predefined pattern, in which case substantial parts of the electrode structure 12 may remain uncovered. It will be appreciated by those skilled in the art that with the production method of the present invention, such a multi-colour liquid crystal display device can be easily produced, because the whole surface of the carrier 10 can be equipped with a regular electrode structure 12, with only the predefined pattern of the multi-colour liquid crystal display device being built-up by means of a plurality of the various discrete liquid crystal elements 110, 130 and 150 as previously shown.

Rather than having to shape an electrode structure in a predefined pattern and cover the whole surface of the carrier 10 with liquid crystal elements, which is a time-consuming and costly process typically associated with segmented display devices, the method of the present invention allows for a more facile way of producing such a multi-colour liquid crystal display device, because the liquid crystal elements 110 can be produced individually on top of the regular electrode structure, thus yielding a more simple and cheaper multi-colour liquid crystal display device that can be produced faster.

The fact that the liquid crystal elements 110 are individually formed on the surface of carrier 10 also facilitates the formation of multi-colour liquid crystal display devices and in particular display devices having a non-rectangular shape, because the formation of the various liquid crystal elements 110, 130 and 150 is no longer related to the shape of carrier 10. In fact, the shape of the carrier 10 may be any shape that allows the formation of a functioning electrode structure 12 on its surface.

The multi-colour liquid crystal display device of the present invention also has particular advantages when the carrier 10 is a flexible carrier. Due to the presence of the discrete polymer layers 114, 134 and 154, a thin flexible display device can be obtained that has improved flexibility characteristics compared to display devices having the LC elements sandwiched between two continuous substrates.

The multi-colour liquid crystal display device of the present invention can be kept thin enough to be rolled up, without causing excessive stress to the various layers of the multi-colour liquid crystal display device in its rolled-up state.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A method of producing a multi-colour liquid crystal display device (1, 4) comprising a plurality of discrete liquid crystal elements on a surface of a carrier (10), the method comprising the steps of:
depositing a plurality of discrete droplets (100; 120, 140) on the carrier surface, the plurality of droplets (100; 120, 140) having at least a first subset and a second subset, a droplet (100) from the first subset being of a first liquid comprising a mixture of a first cholesteric liquid crystal material (102) for interacting with light having a wavelength in a first part of the visible spectrum and a first polymer precursor material (104), and a droplet (120) from the second subset being of a second liquid comprising a mixture of a second cholesteric liquid crystal material (122) for interacting with light having a wavelength in a second part of the visible spectrum and a second polymer precursor material (124);
forming a first subset of the plurality of discrete liquid crystal elements (110) by exposing the first subset of discrete droplets (100) to a stimulus for polymerizing the first polymer precursor material (104) of each of said droplets (100) into a first discrete polymer layer (114) enclosing the first cholesteric liquid crystal material (102) between said first layer (114) and the carrier surface; and
forming a second subset of the plurality of discrete liquid crystal elements (130) by exposing the second subset of discrete droplets (120) to a stimulus for polymerizing the second polymer precursor material (124) of each of said droplets (120) into a second discrete polymer layer (134) enclosing the second cholesteric liquid crystal material (122) between said second layer (134) and the carrier surface.

2. A method as claimed in claim 1, wherein a discrete droplet (100) is formed by depositing a plurality of smaller droplets over a same respective part of the carrier surface.

3. A method as claimed in claim 1 or 2, wherein the step of depositing a plurality of discrete droplets is preceded by modifying the carrier surface by depositing an electrode structure (12) on the carrier surface.

4. A method as claimed in claim 1, 2 or 3, wherein the step of depositing a plurality of discrete droplets is preceded by modifying the carrier surface by depositing an orientation layer (16) on the carrier surface.

5. A method as claimed any of the claims 14, wherein the step of depositing the plurality of discrete droplets is preceded by the step of depositing a pattern of wall structures (202) on the carrier surface for creating a plurality of bordered domains on the carrier surface, a droplet (100, 120, 140) from the plurality of discrete droplets being deposited in such a bordered domain.

6. A method as claimed in any of the claims 1-4, wherein the step of depositing a plurality of discrete droplets is preceded by the step of depositing a plurality of regions (302) of a nonwetting material on the carrier surface.

7. A method as claimed in any of the preceding claims, the method further comprising the step of depositing a further electrode structure (32) over the first and second discrete polymer layers (114; 134).

8. A method as claimed in any of the preceding claims, the method further comprising the steps of:
depositing a further orientation layer (460) over the plurality of discrete liquid crystal elements (110, 130, 150);
depositing a first further subset of a further plurality of discrete droplets (400; 420, 440) over the first subset of discrete liquid crystal elements (110), a droplet (400) from the first further subset of the further plurality of discrete droplets being of a first further liquid comprising a first further cholesteric liquid crystal material (402) and a first further polymer precursor material (404);
depositing a second further subset of the further plurality of discrete droplets over the second subset of discrete liquid crystal elements (130), a droplet (420) from the second further subset of the further plurality of discrete droplets (400; 420, 440) being of a second further liquid comprising a second further cholesteric liquid crystal material (422) and a second further polymer precursor material (424);
modifying the first subset of discrete liquid crystal elements (110) by exposing the first further subset of discrete droplets to a further stimulus for polymerizing the first further polymer precursor material (404) of each droplet into a first further discrete polymer layer (414) enclosing the first further cholesteric liquid crystal material (402) between said first further layer (414) and the further orientation layer (460); and
modifying the second subset of discrete liquid crystal elements (130) by exposing the second further subset of discrete droplets to a further stimulus for polymerizing the second further polymer precursor (424) of each droplet into a second further discrete polymer layer (434) enclosing the second further cholesteric liquid crystal material (422) between said second further layer (434) and the further orientation layer (460).

9. A method as claimed in claim 8, the method further comprising the step of depositing a second further electrode structure (52) over the first further and second further discrete polymer layers (414; 434).

10. A method as claimed in any of the preceding claims, further comprising the step of covering the plurality of discrete liquid crystal elements with a light absorbing coating (24).

11. A multi-colour liquid crystal display device (1, 4) comprising:
a plurality of discrete liquid crystal elements (110; 130, 150) on a surface of a carrier (10), the plurality of discrete liquid crystal elements at least comprising a first subset and a second subset, each liquid crystal element (110) from the first subset comprising a first discrete polymer layer (114) enclosing a first cholesteric liquid crystal material (102) for interacting with light having a wavelength in a first part of the visible spectrum between said first layer (114) and the carrier surface; and
each liquid crystal element (130) from the second subset comprising a second discrete polymer layer (134) enclosing a second cholesteric liquid crystal material (122) for interacting with light having a wavelength in a second part of the visible spectrum between said second layer (134) and the carrier surface.

12. A multi-colour liquid crystal display device (1, 4) as claimed in claim 11, wherein the carrier surface comprises an electrode structure (12).

13. A multi-colour liquid crystal display device (1, 4) as claimed in claim 11 or 12, wherein the carrier surface comprises an orientation layer (14).

14. A multi-colour liquid crystal display device (1, 4) as claimed in claim 11, 12 or 13, wherein the multi-colour liquid crystal display device further comprises a pattern of wall structures (202) for creating a plurality of bordered domains on the carrier surface; a liquid crystal element (110, 130, 150) from the plurality of discrete liquid crystal elements occupying such a bordered domain.

15. A multi-colour liquid crystal display device (1, 4) as claimed in claim 10, 11 or 12, wherein the plurality of discrete liquid crystal elements (110; 130, 150) are separated from each other by means of nonwetting regions (302) on the carrier surface.

16. A multi-colour liquid crystal display device (4) as claimed in any of the claims 11-15, wherein:
the plurality of discrete liquid crystal elements includes a further orientation layer (460) covering the respective first polymer layers (114) and the respective second polymer layers (134);
each liquid crystal element (110) from the first subset further comprises a first further polymer layer (414) enclosing a first further cholesteric liquid crystal material (402) between the first further polymer layer (414) and the further orientation layer (460); and
each liquid crystal element (130) from the second subset further comprises a second further discrete polymer layer (434) enclosing a second further cholesteric liquid crystal material (422) between the second further discrete polymer layer (434) and the further orientation layer (460).

17. A multi-colour liquid crystal display device (4) as claimed in claim 16, wherein:
the first cholesteric liquid crystal material (102) has a first pitch and the first further cholesteric liquid crystal material (402) has a first further pitch, the first pitch and the first further pitch being of opposite sign and being of substantially the same magnitude; and
the second cholesteric liquid crystal material (122) has a second pitch and the second further cholesteric liquid crystal material (422) has a second further pitch, the second pitch and the second further pitch being of opposite sign and being of substantially the same magnitude.

18. A multi-colour liquid crystal display device (4) as claimed in claim 16, wherein:
the carrier (10) is at least partially transparent;
the first further cholesteric liquid crystal material (402) being suited to interact with light having a wavelength in a first further part of the visible spectrum; and
the second further cholesteric liquid crystal material (422) being suited to interact with light having a wavelength in a second further part of the visible spectrum.

19. A multi-colour liquid crystal display device (1, 4) as claimed in any of the claims 11-18, wherein the first and second discrete polymer layers (114; 134) carry a further electrode structure (32).

20. A multi-colour liquid crystal display device (1, 4) as claimed in any of the claims 11-19, wherein the first further and second further discrete polymer layers (414; 434) carry a second further electrode structure (52).

21. A multi-colour liquid crystal display device (1, 4) as claimed in any of the claims 11-20, wherein the plurality of discrete liquid crystal elements (110; 130, 150) are covered by a light absorbing coating (24).

22. A multi-colour liquid crystal display device (1, 4) as claimed in any of the claims 11-21, wherein the carrier (10) is flexible.

23. A multi-colour liquid crystal display device (1, 4) as claimed in any of the claims 11-22, wherein the plurality of discrete liquid crystal elements (110; 130, 150) are covering a predefined part of the carrier surface.
